(19) United States
(12) Patent Application Publication
(10) Pub. No.: US 2003/0207238 A1
(43) Pub. Date: Nov. 6, 2003

(54) Training methods and systems

(76) Inventors: Markus Latzina, Walldorf (DE); Bernard Rummel, Schriesheim (DE)

Correspondence Address: Finnegan, Henderson, Farabow,, Garrett & Dunner, L.L.P., 1300 I Street, N.W., Washington, DC, 20005-3315, US

(21) Appl. No.: 10/330,090

(22) Filed: Dec. 30, 2002

Related U.S. Application Data
(60) Provisional application No. 60/344,334, filed on Jan. 4, 2002.

(51) Int. Cl. G09B 19/00

(52) U.S. Cl. 434/118

(57) ABSTRACT

Systems and methods are provided for training a plurality of learners. In one disclosed embodiment, a method is provided for training a plurality of learners to develop user interfaces for a software application. The software application may be designed to interact with a plurality of users, including a first user and a second user. The exemplary training method may include dividing the plurality of learners into a first group, a second group and a third group, brainstorming by the first group and the second group to generate an overall usage context for the user interfaces, and designing, by the first and second groups, first and second usage scenarios. The first and second groups may provide first and second prototypes for the user interfaces according to the first and second usage scenarios, respectively. In addition, the third group may analyze existing user interfaces to provide assistance to the first and second groups in providing the prototypes.

### CROSS-REFERENCE TO RELATED APPLICATION

This application is related to and claims the benefit of priority under 35 U.S.C. 119(e) to U.S. Provisional Patent Application No. 60/344,334, filed on Jan. 4, 2002, the disclosure of which is expressly incorporated herein by reference in its entirety.

### BACKGROUND OF THE INVENTION

1. Field of the Invention

The present invention generally relates to training methods and related systems, including training systems incorporating computers or computer-based systems. More particularly, the invention relates to training methods and systems, such as training methods and systems for cross-disciplinary usability or user centered development training.

2. Background Information

Human computer interaction (HCl) is of vital importance for any computer software. Usability or user centered development is a cross-disciplinary task. A proper design process involves several activities, such as research, design, and standardization activities, along with coordination needs across development teams. Beginning software developers, for example, need to understand cooperation needs with other professions and members of adjacent teams. Training in usability or user centered development (including user interface (UI) design) and development techniques will typically fail unless these issues are addressed. Further, it is a problem to teach the design methods while, at the same time, creating a strong motivation for intra-team and cross-team cooperation.

Some background information related to this area include:

On User Environment Design and Paper Prototyping:

Beyer, H. and Holtzblatt, K., “Contextual Design,” Morgan Kaufmann, San Francisco, Calif. (1998);

On Personas:

Cooper, A., “The Inmates are Running the Asylum,” Sams, Indianapolis, Ind. (1999);

On Learning Styles:

Kolb, D. A., “Experiential Learning: Experience as the Source of Learning and Development,” Prentice-Hall, Englewood Cliffs, N.J. (1984);

On Training Courses:

UIE (www.uie.com) training course with a simulation game, (but not addressing specifics of real-world development context);

Exemplary Materials for Usability Training Courses:

ZDG045/046 Usability I/II, by SAP Aktiengesellschaft, Walldorf (Baden), Germany; and

On Instructural Design Strategies:

Leshin, C. B., Pollock, J., and Reigeluth, C. M., “Instructional Design Strategies and Tactics,” Educational Technology Publications, Englewood Cliffs, N.J. (1992).

Problem Description

What and how to teach beginning developers about usability or user centered development?

Exemplary Situation: Developers and management expect a short (for example, maximum 2 days) introductory course in usability principles and techniques. In the context of a short course, the following issues may be considered:

Developers are not and will not be usability specialists;

Developers need to effectively cooperate with usability professionals; and/or

Beginning developers go through several months of training and a “usability” course is one course among many others.

Exemplary Learning Goals: With regard to usability or user centered development for beginning developers, learning goals may include:

Know the components of design methods and their interrelationships;

Accept and understand the division of labor with user interface designers and other usability specialists; and/or

Know relevant resources.

The exemplary situation may result in a topic×role matrix of learning goals: skills and attitudes necessary for successful cooperation within the ecology of professional roles at the company. An analysis of this matrix may reveal a prioritization of the requirements mentioned above, such as:

First priority: Attitude or mind change towards better acceptance of expertise from non-technical professions in the development process;

Second priority: Be able to participate in usability or user centered development activities; and/or

Third priority: Know relevant usability or user centered development resources of the company, such as contacts, guidelines, infrastructure, learning materials, and/or resources (text, web-based, etc.).

Additional Training Requirements: As identified on the basis of prospective participants analysis, additional training requirements may include:

Design activities must visibly speed up the development process—the training situation is to demonstrate this;

Training must respect and foster the company's core values, as for example self-responsibility;

Training must respect the professional identity of software developers, as for example initiative, self-motivated action; and/or

Training in usability or user centered software development techniques must be rewarding in order to achieve motivational learning goals.

### SUMMARY OF THE INVENTION

Methods and systems consistent with embodiments of the present invention provide methods and systems for training users, students, participants or other individuals (generally referred to herein as “learners”). Such training methods and systems may be implemented to provide, for example, training for cross-disciplinary usability or user centered development training.

In accordance with an embodiment of the invention, methods and systems provide an instructional design for a training course. Such methods and systems may comprise:

Learning style assessment;

A simulation game as a core learning activity or experience and embedded in a company-specific introductory usability course;

Multi-component scenario involving various team roles, and development platforms;

Addressing team dynamics, time pressure, and coordination needs;

Defined learning tasks tailored to meet specific learning objectives; and/or

Transfer knowledge into professional practice.

According to other embodiments of the present invention, training methods and systems provide training to users through the use of a course outline.

The course outline may comprise:

General introduction and establishing the learning setting;

Moderated exercise: Building Personas (e.g., following the approach by Cooper, concrete manifestation of a role by a fictive character);

Lecturette: The Value of Site Visits;

Simulation game: “Pizza Service Solution”;

Lessons learned from the simulation game;

Essential usability resources at the company; and/or

Transfer knowledge into professional practice.

In accordance with still other embodiments of the invention, a method may be provided for training a plurality of learners to develop user interfaces for a software application that interact with a plurality of users, including a first user and a second user. The method may include: dividing the plurality of learners into a first group, a second group and a third group; brainstorming, by the first group and the second group, to generate an overall usage context for the user interfaces; designing, by the first group and the second group, first and second usage scenarios; providing, by the first group and the second group, first and second prototypes for the user interfaces according to the first and second usage scenarios, respectively; and analyzing, by the third group and in parallel to at least designing, existing user interfaces to provide assistance to the first and second groups in providing the prototypes.

It is to be understood that both the foregoing general description and the following detailed description are exemplary and explanatory only, and should not be deemed restrictive of the full scope of the embodiments of the present invention.

### BRIEF DESCRIPTION OF THE DRAWINGS

The accompanying drawings, which are incorporated herein and constitute a part of this specification, illustrate various features and aspects of embodiments of the invention. In the drawings:

FIG. 1 illustrates an exemplary computer system environment, consistent with embodiments of the invention;

FIGS. 2A-2E are graphical representations of exemplary learning tasks, consistent with embodiments of the invention;

FIGS. 3A and 3B are graphical representations of additional exemplary learning tasks, consistent with embodiments of the invention;

FIG. 4 is a simplified illustration of an exemplary software application with first and second user interfaces for first and second users, respectively; and

FIG. 5 is a simplified flowchart diagram of an exemplary training method, consistent with embodiments of the present invention.

### DETAILED DESCRIPTION

Embodiments of the present invention are explained herein in connection with examples. For instance, in an exemplary scenario, learners are invited to design a service (such as a pizza delivery service), including multiple software platforms, user roles, prototypes, screen designs, and/or networking. Persons of ordinary skill in the art can apply the idea to other applications, such as for example, car distribution and car configuration by customers, in a similar fashion.

Embodiments of the invention may comprise an instructional design for an introductory usability or user centered development workshop. The training workshop may be implemented in various ways. For instance, training methods and systems may be implemented according to the following structure or features:

(1) Preparation of a learning setting using learning styles self-assessment;

(2) Recognizing good design: Tutorial on user interface design evaluation using personas;

(3) Simulation Game (example described: “Pizza Service Solution”): The simulation game may include multiple components. For example, in the pizza service example, participants may design software products for multiple technical platforms, such as: an Internet device (e.g., browser-based), a client/server computer system (e.g., running SAP R/3), a handheld computer (so-called palmtop computers) or any other computer. “Development” groups .1, .2, and .4 may design and develop prototypes (such as paper prototypes or drafts prepared by hand using, for example, pen-based computers) under time pressure. A further group .3 (“Task Force”) may perform supportive research on user scenarios, style-guides, and/or terminology. The Task Force .3 may also coordinate the development groups .1, .2, .4. Further, in a final phase of the game, the task force .3 may try to influence the design created by the development groups;

(4) Reflection: Lessons learned from the simulation game. Collection of statements from learners;

(5) Introduction to company's usability resources: Search tasks in a company intranet, combined with a simulated low-fidelity usability test;

(6) Transfer of knowledge preparation: Forming intentions, building commitment, transfer facilitation by learning peer system, and learning contract; and/or

(7) Implementing the details of the exemplary Tables provided herein, including the respective descriptions of learning goals and instructional techniques applied.

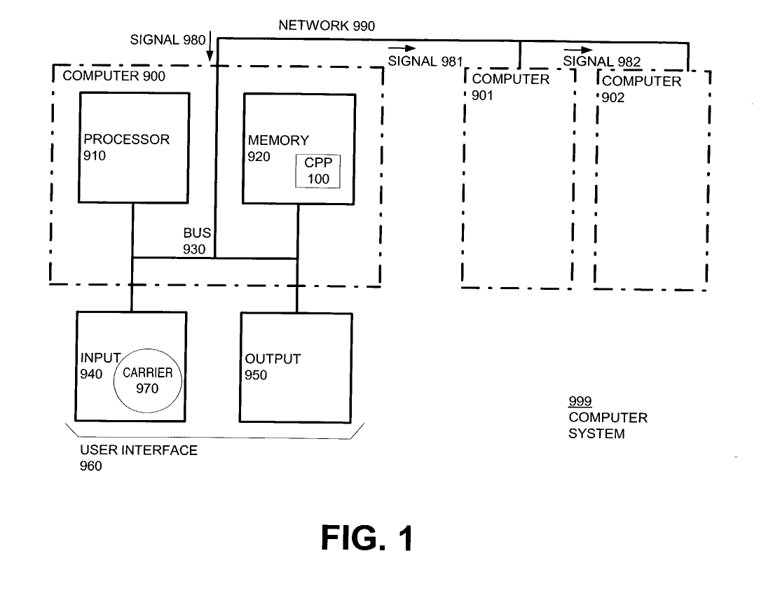

Embodiments of the present invention may be implemented by computers and/or network environments (see, for example, computer system 999 of FIG. 1). For instance, learners may use computers to access the Internet and/or an intranet, print out templates, fill out forms, and/or view presentation files.

Consistent with embodiments of the present invention, one or more predetermined flows of events (see, for example, the Tables provided herein) may be supported by predefined control functionality of a computer program product (CPP 100) to guide the learners through their sequence of learning tasks. In other words, training may be intrinsically enabled by computers. The use of computers makes it possible to follow the sequence of events as specified.

Embodiments of the invention may comprise: (1) creation of specific events in a simulation game which create specific learning experiences for learners or participants, as reflected in reproducible statements from learners; (2) instructional design based on needs analysis, which makes the course customizable to concrete organizational contexts (e.g., core competences as defined by the training host's corporate culture & HR policies); (3) trainer- and/or peer-based performance evaluation fostering attitudinal learning goals and realism; (4) process reflection phase; and/or (5) transfer of knowledge induction phase involving a learning contract with classmates or learning peers.

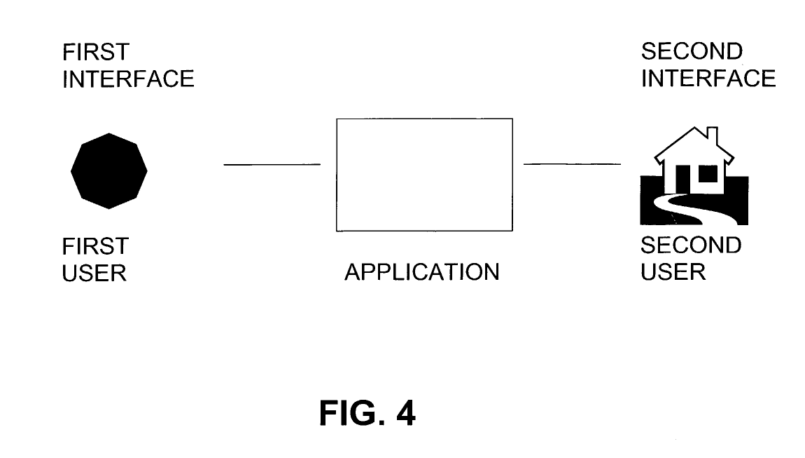

FIG. 4 is a simplified illustration of an exemplary software application with first and second user interfaces for first and second users, respectively. In the example of a pizza service application, the first user is a customer who interacts with the first interface that displays a picture or image that includes a pizza. The second user may be a driver who interacts with the second interface that displays a roadmap to the location of the customer.

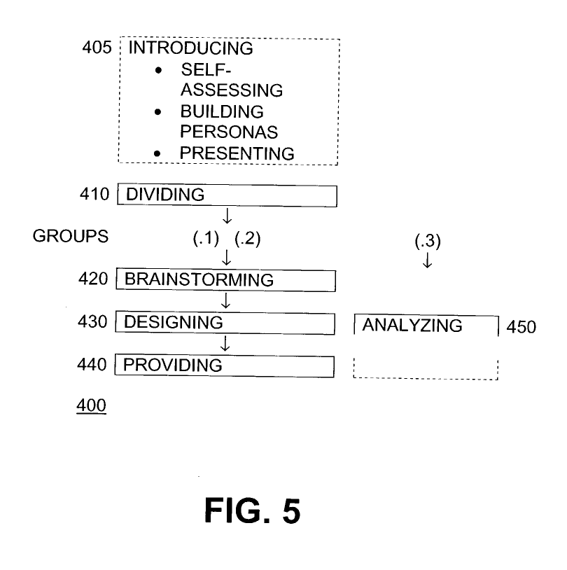

FIG. 5 is a simplified flowchart diagram of an exemplary training method 400, consistent with embodiments of the present invention. In FIG. 5, plain boxes represent main steps in the exemplary method, and dashed boxes represent auxiliary steps that are performed optionally and stand for extensions of the main steps. Further, in FIG. 5, Groups .1, .2 and .3 indicate first, second and third learner groups. FIG. 5, however, is not limited to using three groups and additional groups (such as Group .4, etc.) may be similarly designated.

Method 400 may be implemented for training a plurality of learners to develop, for example, user interfaces for a software application for interacting with a first user and a second user. As illustrated in the embodiment of FIG. 5, method 400 may include a number of steps, such as: dividing 410 the plurality of learners into a first group, a second group and a third group (e.g., Groups .1, .2, and .3); brainstorming 420 by the first group and second group to generate an overall usage context for the user interfaces; designing 430 first and second user environments or usage scenarios by the first and second groups, respectively; providing 440, by the first and second groups, first and second prototypes (such as paper prototypes or other types of prototypes), respectively, for the user interfaces according to the first and second user environments or usage scenarios, respectively; and analyzing 450 existing user interfaces, by the third group and in parallel to at least designing 430, to provide assistance to the first and second groups in providing 440 the prototypes.

Optionally, in the embodiment of FIG. 5, further groups may participate. By way of example, in the exemplary implementation for a pizza service (i.e., software application), the three groups may be referred to as: “consumers” first group .1; “delivery drivers” second group .2; and “task force” third group .3. The exemplary implementation may also incorporate a fourth group “baker”.4. Conveniently, the groups are numbered and referenced herein with a dot symbol.

Consistent with embodiments of the invention, different user environments or usage scenarios may be employed. For example, returning the previous pizza service application, the usage scenarios for groups .1, .2, and .4 may include: Group .1—“a computer user and pizza customer operate a browser to access software for ordering pizza,” as a first usage scenario; Group .2—“the driver has a handheld computer that shows him/her the way to the customer,” as a second usage scenario; and Group .4—“the baker operates a computer that indicates incoming orders, material availability, pizza configuration options and the like,” as another scenario.

Dividing into groups has the advantage to create conflicts and to solve the conflicts later on, thus emulating real software development work practice. The analysis and assistance by the third group task force (Group .3) is beneficial and time-saving to both groups. Also, the task force may facilitate communication between the groups, such as the first and second groups, at predefined time points during designing and, optionally, prototyping.

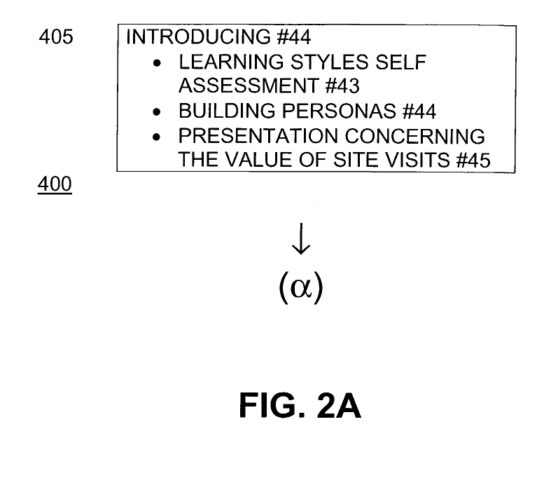

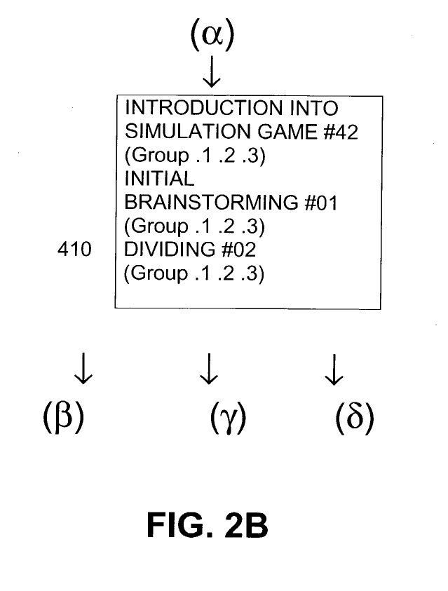

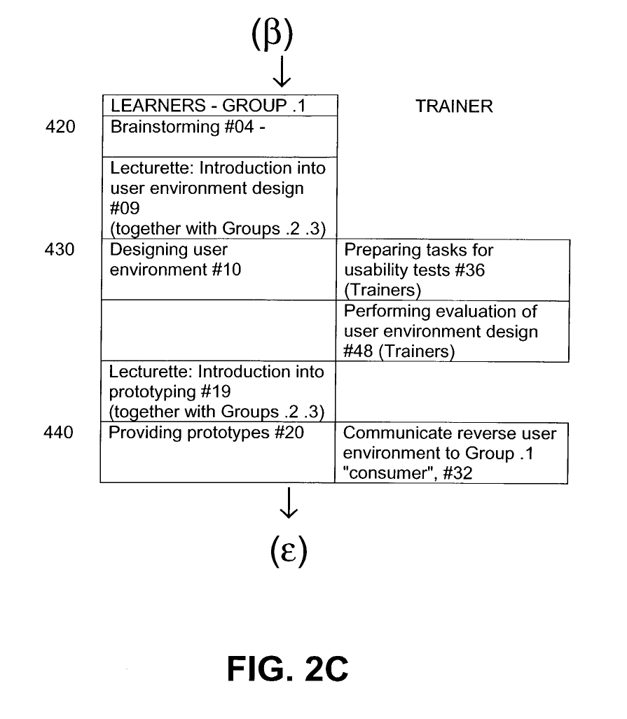

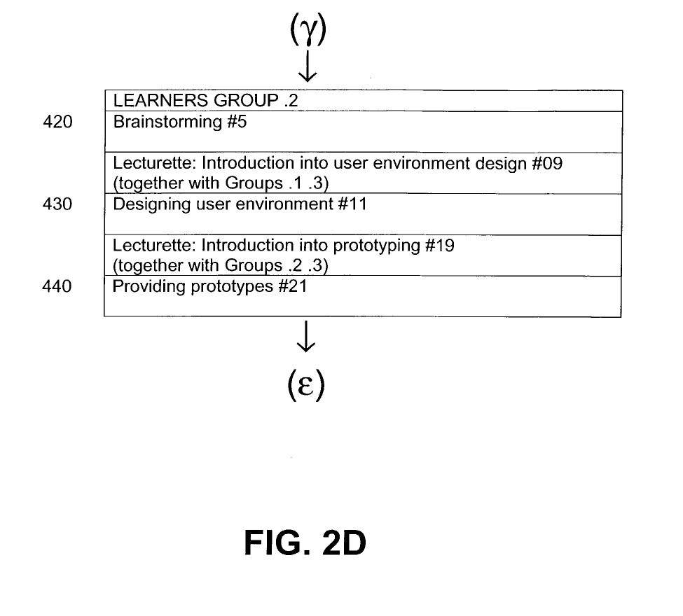

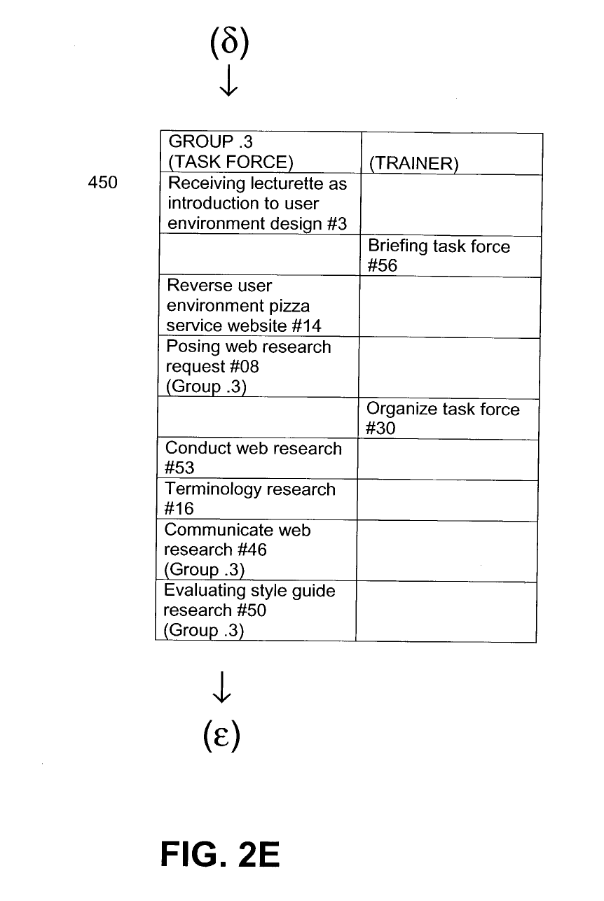

Briefing of the learners by trainers prior to performing certain steps is recommended (see, for example, Table 12/#56). Further, providing one or more lecturettes is convenient and may also be implemented in the exemplary method (see, for example, Table 13/#03 and FIG. 2E, Table 17/#09, Table 18/#31, and elsewhere). Additionally, for convenience, steps 420 and 450 of FIG. 5 may collectively be referred to as a “simulation game”.

As will be appreciated by those skilled in the art, the exemplary training method 400 may be modified or adjusted according to the needs of the application or training environment. Further, the above described steps may be re-ordered, modified or substituted, and/or additional steps may be incorporated into method 400. For instance, the step of introducing 405 may be performed prior to dividing 410 and brainstorming 420 (see, for example, the details of Table 2/#42).

Various other features may be provided in the exemplary training method. For instance, introducing 405 may comprise self-assessing the learning style(s) by the learners (see, for example, the details of Table 3/#43). In one embodiment, the step of self-assessing the learning style(s) is performed by substantially all of the plurality of learners. Further, self-assessing the learning style(s) may comprise having the learners respond to a predefined questionnaire. Additionally, or alternatively, self-assessing the learning style(s) may comprise tasking the learners to stick or place dots to a flipchart with a coordinate system, wherein the dots anonymously represent the responses to questions (such as questions of a predefined questionnaire) and are visible to the plurality of learners.

In one embodiment of the invention, it is an advantage that a learner knowing their learning style can go through subsequent steps more efficiently and that assistants (like participating trainers) can optionally adjust further steps to the particular styles of the learners. Hiding individual skills may help the learners to concentrate on the skills of the plurality of learners and may also help the learners to compete with each other.

In the exemplary method 400, introducing 405 may comprise building personas (see, for example, the details of Table 4/#44). Building personas may include, for example, performing an exercise that is moderated by a trainer. In one embodiment, performing a moderated exercise may include presenting a public website without a persona, presenting a sample persona, creating ad hoc a persona from a picture, navigating through one or more web sites using the persona and/or collecting feedback from the learners.

Other features may be added or incorporated to the exemplary method 400. For instance, introducing 405 may comprise presenting a slide show relating to the value of site visits (see, for example, the details of Table 5/#45). In another embodiment, dividing 410 is performed by using random techniques (see, for example, the details of Table 7/#02). Additionally, or alternatively, dividing 410 is performed by randomly distributing tags with symbols to substantially all learners, wherein the number of different symbols on the tags corresponds to the number of groups. In another embodiment, dividing 410 is performed with symbols selected from the group of: a star, square, circle, and triangle. In one embodiment, it is an advantage that a random distribution is provided to speed up the dividing of learners into groups.

Initial brainstorming may be performed by all learners prior to dividing 410 (see, for example, the details of Table 6/#01). In one embodiment, initial brainstorming is performed by providing a flip chart, making a manikin sketch on the flip chart, and/or giving the manikin a name and letting the learners experience the effects. Optionally, the exemplary training method may include letting the learners experience the effects of using concrete environmental settings. In one embodiment, it is an advantage that the manikin (e.g., drawn in the center of a flip chart) is a predecessor of a persona. The learners find themselves in the position of the persona. It is helpful to give the persona a name (e.g., “John”) that is common among the learners but that is not present among the learners being trained. The learners remember similar situations in life, such as being a hungry pizza customer accessing the Internet site of a pizza service. More likely, the learners develop interface prototypes that fit to that persona.

Consistent with embodiments of the invention, other features may be provided or incorporated into the exemplary method 400. For example, the initial brainstorming may enable the learners to identify important roles in the first and second usage scenarios. By way of example, the step of brainstorming 420 may be performed by focusing on the role of one of the users of the first and second usage scenarios, respectively. Focusing on the role of one of the users may comprise defining a usage context with a location of this user, an estimated time of day, and/or estimated current actions of this user. In one embodiment, it is an advantage to define the context near to reality, for example, for a possible user (i.e., a pizza customer). Similar to brainstorming with the manikin, the user can be given a name.

In the exemplary method 400, brainstorming 420 may include drawing a brainstorming diagram. Advantageously, the diagram may be drawn on a board that is visible to all participants, such as on a flip-chart. Additionally, brainstorming 420 may comprise creating a list of questions for the third group. The list of questions may be handed to the third group by the trainers and, if appropriate, the trainers may modify the list. In one embodiment, it is an advantage that the trainers can delete, for example, superfluous tasks from the list of questions that are time-consuming, expensive to answer, misleading, etc. (see, for example, the details of Table 19/#33).

Analyzing 450 in the exemplary method 400 may comprise tasking the third group to search in predetermined resources, wherein the search is based on the performance of brainstorming 420 by the first and second groups. By way of example, analyzing 450 may comprise searching in resources selected from the group of: hand-outs, interviews of people outside the plurality of learners, and publicly accessible information (e.g., resources publicly accessible by electronic means). Additionally, or in the alternative, company-owned resources can be used. In one embodiment, it is an advantage to let the learners use resources that are public. Also, on a case-by-case basis, trainers may decide to use limited resources that are specially prepared for the training, such as hand-outs. Resources that are restricted as “company internal” can be used as well.

Analyzing 450 may include other features or tasks. For example, analyzing 450 by the third group may comprise tasking a first team of the third group to do style guide research and tasking a second team of the third group to do web research. In one embodiment, it is an advantage that the learners of the third group learn from some of the web sites or pages in terms of the motivation, expectations, needs, and/or goals of consumers, delivery drivers, or pizza bakers. The members may see implications for the design of the solutions and get specific questions that they investigate. Further, the third group .3 may communicate the results back to the development groups .1, .2, and .4 as fast as possible (see, for example, the details related to the style guide in Table 36/#34 and Table 45/#35).

Various steps may be added or inserted to the exemplary method 400. For instance, subsequent to brainstorming 420 and prior to designing 430, the step of presenting a lecturette to the learners of the first and second groups may be performed as an introduction into user environment design (see, for example, the details of Table 17/#09). Conventional techniques or approaches may be implemented as part of this step, such as those disclosed in the above-referenced Beyer et al. document entitled “Contextual Design.”

Other steps or procedures may also be incorporated into the exemplary method 400. For instance, prior to analyzing 450, the step of presenting a lecturette to the learners of the third group may be performed as an introduction into user environment or usage scenario design. In this regard, the details of Table 18/#31 may be utilized to implement this step. As will be appreciated by those skilled in the art, however, embodiments of the invention are not limited to the exemplary Tables, and other approaches and techniques can be implemented according to the needs or objects of the application or training environment.

As indicated above, presenting the lecturette may comprise presenting the lecturette to the third group (see, for example, Table 18/#31). In one embodiment, it is an advantage that, for example, two or more members distribute their knowledge to the other members of the other groups. In the meantime, the other members could check technical details for analyzing 450.

In one embodiment, designing 430 may comprise tasking the learners to fill out templates and arrange the templates on a pin board. During designing 430, templates on the pin board may reflect the user environment or usage scenario design for the user interface (see ,for example, the details of Table 20/#10, Table 21/#11, and Table 22/#12). Designing 430 may also include testing the user environment design with the previous results from brainstorming 420 (see, for example, Table 23/#36). Further, designing 430 may comprise preparing tasks for usability tests (see, for example, Table 23/#36 and Table 43/#24). In one embodiment, designing 430 includes preparing the tasks by trainers substantially simultaneously with the learners filling out the templates.

Subsequent to designing 430 and prior to providing 440 prototypes, the presentation of a lecturette to the learners may be performed as an introduction into prototyping, such as paper prototyping. Further, providing 440 prototypes may be followed by briefing the learners on testing and reviewing the prototype (see, for example, Table 42/#55). Additionally, or alternatively, providing 440 prototypes may be followed by conducting a prototype usability test. The prototype usability test can be conducted based on task descriptions. In the exemplary method 400, providing 440 prototypes may also be followed by conducting a terminology review by the third group (see, for example, the details of Table 44/#28). In one embodiment, conducting a terminology review comprises reviewing the terminology of user interface elements and/or application content (see, for example, the details of Table 34/#16 and Table 35/#17).

As part of the exemplary training method 400, assistance may be provided by the third group to the other groups. For instance, assistance may be provided to the first and second groups. In one embodiment, providing assistance comprises permitting communication between the third group and selectively the first group and the second group only temporarily.

In the exemplary method 400, brainstorming 420 and designing 430 may be performed for the first group and for the second group in visual separation from the third group. In such a case, communication between the first and second groups with the third group may be allowed only temporarily. For example, separation may be provided by organizing the groups into separate rooms.

The learners may be trained to develop user interfaces on technical platforms selected from the group of: Internet-based platforms (e.g., browser-based), handheld and wireless computers (so-called palmtop computers), and client/server computer systems (e.g., graphical user-interface based). As will be appreciated by those skilled in the art, other platforms may be provided and, therefore, embodiments of the invention are not limited to the examples listed above.

In the exemplary method 400, the steps of dividing 410, brainstorming 420, designing 430, providing 440 and analyzing 450, as well as the assignment of learners to the groups for the steps, may be supported and supervised by a computer program 100. Using a computer has the advantage that the steps can be made to follow a predetermined order and that the learners are notified for each step what they are supposed to do.

As will be appreciated by those skilled in the art, other features can be added to the disclosed embodiments of the invention. For instances, further features such as breaks can be added between and/or during certain steps. Additionally, the timing or duration of each of the steps of the training method may be decided or set according to the needs of the application or training environment.

Exemplary Computer System in General

An exemplary computer system environment for implementing embodiments of the invention is explained below with reference to FIG. 1. In the exemplary network environment, computers may allow trainers and one or more groups (e.g., the third group) to access the same data and, thus, a multi-user environment may be facilitated. Further, trainers may use presentation devices (such as output device 950) for training. Presentation devices may include, for example, projectors.

With reference to FIG. 1, a simplified block diagram is provided of an exemplary system environment that includes a computer network system 999 having a plurality of computers 900, 901, 902 (or 90q, with q=0 . . . Q−1, Q any number). As shown, computers 900-902 may be coupled via an inter-computer network 990. Further, computer 900 may include a number of components, including a processor 910, a memory 920, a bus 930, and, optionally, an input device 940 and an output device 950 (I/O devices or user interface 960). As illustrated, embodiments of the invention may be implemented by computer program product 100 (CPP), program carrier 970 and/or program signal 980, collectively “program”.

With respect to computer 900, computer 901/902 is sometimes referred to as “remote computer.” Computer 901/902 is, for example, a server, a router, a peer device or other common network node, and typically comprises many or all of the elements described relative to computer 900. Hence, elements 100 and 910-980 in computer 900 collectively illustrate also corresponding elements 10q and 91q-98q (shown for q=0) in computers 90q.

Computer 900 is, for example, a conventional personal computer (PC), a desktop, a hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer, or the like.

Processor 910 is, for example, a central processing unit (CPU), a micro-controller unit (MCU), digital signal processor (DSP), or the like.

Memory 920 symbolizes elements that temporarily or permanently store data and instructions. Although memory 920 is conveniently illustrated as part of computer 900, memory functions can also be implemented in network 990, in computers 901/902 and/or in processor 910 itself (e.g., a cache or register), and/or elsewhere. Memory 920 can be a read only memory (ROM), a random access memory (RAM), or a memory with other access options. Memory 920 may be physically implemented by computer-readable media, such as, for example: (a) magnetic media, like a hard disk, a floppy disk, or other magnetic disk, a tape, and/or a cassette tape; (b) optical media, like an optical disk (e.g., a CD-ROM) or a digital versatile disk (DVD); or (c) semiconductor media, like DRAM, SRAM, EPROM, EEPROM, memory stick, or by any other media, like paper.

Optionally, memory 920 is distributed across different media. Portions of memory 920 can be removable or non-removable. For reading from media and for writing in media, computer 900 may use devices well known in the art such as, for example, disk drives, tape drives and the like.

Memory 920 stores support modules such as, for example, a basic input output system (BIOS), an operating system (OS), a program library, a compiler, an interpreter, and/or a text-processing tool. Support modules are commercially available and can be installed on computer 900 by those of skill in the art. For simplicity, these modules are not illustrated in FIG. 1.

CPP 100 comprises program instructions and, optionally, data that cause processor 910 to execute method steps of embodiments of the present invention. Method steps of embodiments of the invention are explained in greater detail herein. In other words, CPP 100 defines the operation of computer 900 and its interaction in network system 999. For example and without the intention to be limiting, CPP 100 can be available as source code in any programming language, and as object code (“binary code”) in a compiled form. Persons of ordinary skill in the art can use CPP 100 in connection with any of the above-noted support modules (e.g., a compiler, an interpreter, an operating system, etc.).

Although CPP 100 is illustrated as being stored in memory 920, CPP 100 can be located elsewhere. CPP 100 can also be embodied in carrier 970.

Carrier 970 is illustrated outside computer 900. For communicating CPP 100 to computer 900, carrier 970 may be conveniently inserted into input device 940. Carrier 970 may be implemented as any computer readable medium, such as a medium largely explained above (see, for example, memory 920). Generally, carrier 970 is an article of manufacture comprising a computer readable medium having computer readable program code means embodied therein for executing methods of embodiments of the present invention. Further, program signal 980 can also embody computer program 100. Signal 980 travels on network 990 to computer 900.

Having described CPP 100, program carrier 970, and program signal 980 in connection with computer 900 is convenient. Optionally, program carrier 971/972 (not shown) and program signal 981/982 embody computer program product (CPP) 101/102 to be executed by processor 911/912 (not shown) in computers 901/902, respectively.

Input device 940 symbolizes a device that provides data and instructions for processing by computer 900. For example, device 940 is a keyboard, a pointing device (e.g., a mouse, a trackball, or cursor direction keys), a microphone, a joystick, a game pad, a scanner, and/or a disk drive. Although the examples are devices with human interaction, device 940 can also operate without human interaction, such as a wireless receiver (e.g., with satellite dish or terrestrial antenna), a sensor (e.g., a thermometer), or a counter (e.g., goods counter in a factory). Input device 940 can serve to read carrier 970.

Output device 950 symbolizes a device or arrangement of devices that present instructions and/or data that have been processed. For example, a monitor or a display (e.g., a cathode ray tube (CRT), a flat panel display, a liquid crystal display (LCD)), a projector, a speaker, a printer, a plotter, and/or a vibration alert device may be provided. Similar as above, output device 950 communicates with the user, but it can also communicate with further computers.

Input device 940 and output device 950 can be combined into a single device. Further, input device 940 and/or output device 950 may be provided optionally.

Bus 930 and network 990 provide logical and physical connections by conveying instruction and data signals. While connections inside computer 900 are conveniently referred to as “bus 930”, connections between computers 900-902 are referred to as “network 990”. Optionally, network 990 may comprise gateways being computers that specialize in data transmission and protocol conversion.

Devices 940 and 950 are coupled to computer 900 by bus 930 (as illustrated in FIG. 1) or by network 990 (optional). While the signals inside computer 900 are mostly electrical signals, the signals in network are electrical, magnetic, optical and/or wireless (radio) signals.

Networking environments (as network 990) are commonplace in offices, enterprise-wide computer networks, intranets and/or the Internet (i.e., World Wide Web). The physical distance between a remote computer and computer 900 is not important. Network 990 can be a wired or a wireless network. To name a few network implementations, network 990 is, for example, a local area network (LAN), a wide area network (WAN), a public switched telephone network (PSTN), an Integrated Services Digital Network (ISDN), an infra-red (IR) link, a radio link, like Universal Mobile Telecommunications System (UMTS), a Global System for Mobile Communication (GSM), a Code Division Multiple Access (CDMA) system, or a satellite link.

Transmission protocols and data formats are known, for example, as transmission control protocol/internet protocol (TCP/IP), hyper text transfer protocol (HTTP), secure HTTP, wireless application protocol (WAP), unique resource locator (URL), a unique resource identifier (URI), hyper text markup language (HTML), extensible markup language (XML), extensible hyper text markup language (XHTML), wireless application markup language (WML), Standard Generalized Markup Language (SGML), etc.

Interfaces coupled between the elements are also well known in the art. For simplicity, interfaces are not illustrated in FIG. 1. An interface can be, for example, a serial port interface, a parallel port interface, a game port, a universal serial bus (USB) interface, an internal or external modem, a video adapter, and/or a sound card.

Computer and program are closely related. As used hereinafter, phrases, such as “the computer provides” and “the program provides” are convenient abbreviations to express actions by a computer that is controlled by a program.

Further Details for Exemplary Computer System Implementation

Consistent with embodiments of the invention, CPP 100 may comprise one or more of the following modules:

View Module: Module for viewing presentations;

Form Module: Module for filling out and printing forms;

Research Module: Module for providing or displaying search and analysis results (e.g., Internet or intranet search results);

Print Module: Module for printing task lists, task instructions, learners' results, etc.;

Retrieval Module: Module for retrieving corporate standards and guidelines; and/or

Collect Module: Module for collecting feedback and input from learners (for consideration by the trainer).

Further, CPP 100 may comprise means to coordinate the action of each module. Such means may comprise, for example, an automatic scheduler. The modules of the computer system may communicate via a network. In addition, CPP 100 may have program portions on multiple computers.

Additional Embodiments and Proof of Concept

After the Simulation Game, in the Reflection Phase, learners or participants may make spontaneous key statements for establishing a user centered development process. One or more of the following exemplary statements can be reproduced:

Time and proper project management are required to roll in user/task information, usability standards;

The user perspective has advantages when compared to a purely technical perspective;

Data-based design is a necessity;

Developers feel bothered by task force and task force is disappointed by lack of interest in results;

Development teams become aware of their autistic behavior;

Task force members become aware of communication needs; and/or

Everyone sees the cost of communication-you need to look beyond your team to see the benefits.

Learners or participants can also spontaneously develop one or more solution ideas (which they will remember later at work), for example:

Task Force (or the functional equivalent) needs a coordinating role in the development process;

Development teams need coordinators talking to adjacent teams;

Network communication structure; a task force member may switch between groups; and/or

An internal design reviewer role is suggested to foster standardization and motivate for communication.

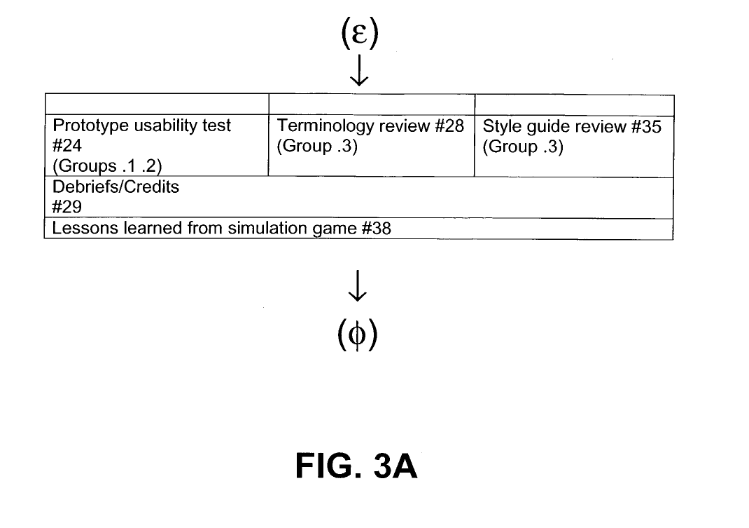

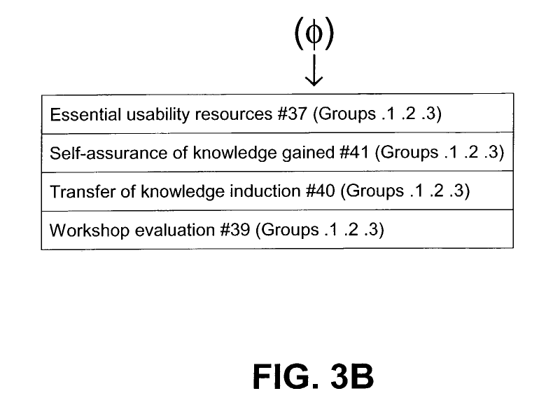

Consistent with additional embodiments of the invention, the following is an exemplary description of individual learning tasks, their sequence, and the computer modules for enabling their processing, and an overview of learner and trainer activities that may be provided according to an exemplary timeline. To facilitate the reader, an exemplary sequence flow for the tasks illustrated in FIGS. 2-3 is indicated by arrows and Greek letters (α, β, etc.). This sequence flow may be modified according to the application or training environment. In addition, breaks or other actions may be added to the learning tasks or sequence flow, consistent with embodiments of the invention.

Terms

In the Tables and accompanying figures (see FIGS. 2 and 3), the following terms are used:

Brainstorming Group

Brainstormers are the Members of the Brainstorming Group

Chair of Simulation Game

Learner

Simulation Game

Task Force

Trainer, not Instructors, not Speakers (but: Chair of Simulation Game)

Development Group: super-category for Brainstorming Group, Prototyping Group, excluding Task Force, excluding Task Group

Workshop, preferable to alias Course

Workshop stands for a Room

“Lecturette” stands for a short oral presentation

Tasks Index

In the Tables and figures (see FIGS. 2-3), tasks have the following indices and legends:

T1=Trainer 1

T2=Trainer 2

Sequence: chronological sequence in the course design; gaps are left intentionally; parallel tasks are indicated by equal sequence numbers, a comma, and an additional identifying number

Who: Owner

Id: identification number of the learning task

Sequ. represents sequence numbers. Equal pre-comma numbers indicate equal time points (e.g., 130,1 and 130,2 at the same time)

TABLE 1

| | | | Id/ | Learning Task |
|---|---|---|---|---|
| Day | Sequ. | Who | Table | Title |
| 1 | 10 | T2 or T1 | #42/2 | Introduction |
| | | .1 .2 .3 .4 | | |
| 1 | 20 | T2 or T1 | #43/3 | Learning Styles Self-Assessment |
| | | .1 .2 .3 .4 | | |
| 1 | 30 | T1 or T2 | #44/4 | Building Personas |
| | | .1 .2 .3 .4 | | |
| 1 | 40 | T1 or T2 | #45/5 | Value of Site Visits |
| | | .1 .2 .3 .4 | | |
| 1 | 110 | T2 or T2 | #01/6 | Brainstorming, facilitated by trainers |
| | | .1 .2 .3 .4 | | |
| 1 | 120 | T2 or T1 | #02/7 | Splitting up (dividing) into small groups & rooms |
| | | .1 .2 .3 .4 | | |
| 1 | 130,1 | T2 | #04/8 | Brainstorming (group led) Consumer .1 |
| | | .1 | | |
| 1 | 130,2 | T2 | #05/9 | Brainstorming (group led) Delivery driver .2 |
| | | .2 | | |
| 1 | 130,3 | T2 | #06/10 | Brainstorming (group led) Pizza Baker .4 |
| | | .4 | | |
| 1 | 130,4 | T1 | #56/12 | Brief Task Force .3 |
| | | .3 | | |
| 1 | 130,5 | T1 | #03/13 | Receive Lecturette: Introduction to UE Design |
| | | .3 | | |
| 1 | 140 | T1 | #14/14 | Reversed user environment of pizza service in |
| | | .3 | | the web (Consumer Perspective - first user) |
| 1 | 150 | T2 | #08/15 | Pose Web Research Request |
| | | .1 .2 .4 | | |
| 1 | 155 | T2 | #47/16 | Performance Evaluation: Brainstorming |
| 1 | 160,1 | T1 | #09/17 | Receive Lecturette: Introduction into User |
| | | .1 .2 .4 | | Environment Design |
| 1 | 160,2 | T1 | #31/18 | Give Lecturette: Introduction into User |
| | | .3 | | Environment Design |
| 1 | 160,3 | T2 | #33/10 | Modify Web Research Request |
| 1 | 170,1 | T1 | #10/20 | User Environment Design (group led) Consumer |
| | | .1 | | |
| 1 | 170,2 | T1 | #11/21 | User Environment Design (group led) Delivery driver |
| | | .2 | | |
| 1 | 170,3 | T1 | #12/22 | User Environment Design (group led) Pizza |
| | | .4 | | Baker |
| 1 | 180,1 | T1 | #36/23 | Prepare Tasks for Usability Tests |
| 1 | 180,2 | T2 | #30/24 | Organize Task Force 1 |
| | | .3 | | |
| 1 | 190,1 | T2 | #15/25 | Conduct Web Research: Pizza Service in the |
| | | .3 | | Web 1 |
| 1 | 190,2 | T2 | #34/26 | Style Guide Research |
| | | .3 | | |
| 1 | 190,6 | T2 | #57/27 | Performance Evaluation: reverse user |
| | | | | environment design (as created in #14) |
| 1 | 195 | T1 | #48/28 | Performance Evaluation: User Environment |
| | | | | Design |
| 1 | 200 | T1 | #19/30 | Lecturette: Introduction into Paper Prototyping |
| | | .1 .2 .4 | | |
| 1 | 210 | T1 | #32/29 | Communicate Reverse User Environment to |
| | | .1 .3 | | Prototyping Group “Consumer” |
| 1 | 215 | T2 | #54/31 | OrganizeTask Force 2 |
| | | .3 | | |
| 1 | 220,0 | T2 | #53/32 | Conduct Web Research: Pizza Service in the |
| | | .3 | | Web 2 |
| 1 | 220,1 | T2 | #46/33 | Communicate Web Research (to .1 .2 .4) |
| | | .3 | | |
| 1 | 220,2 | T2 | #16/34 | Terminology: User Interface |
| | | .3 | | |
| 1 | 220,3 | T2 | #17/35 | Terminology: Content |
| | | .3 | | |
| 1 | 220,4 | T2 | #20/36 | Paper Prototyping (Group Led) Consumer |
| | | .1 | | |
| 1 | 220,5 | T2 | #21/37 | Paper Prototyping (Group Led) Delivery driver |
| | | .2 | | |
| 1 | 220,6 | T2 | #22/38 | Paper Prototyping (Group Led) Pizza Baker |
| | | .4 | | |
| 2 | 221 | T1 or T2 | #55/42 | Briefing Test & Reviews |
| | | .1 .2 .3 .4 | | |
| 2 | 225,1 | T2 or T1 | #49/39 | Performance Evaluation: Terminology Research |
| 2 | 225,2 | T1 or T2 | #50/40 | Performance Evaluation: Style Guide Research |
| 2 | 225,3 | T2 or T1 | #51/41 | Performance Evaluation: Web Research |
| 2 | 230,1 | T2 or T1 | #24/43 | Prototype Usability Test |
| | | .1 .2 .3 .4 | | |
| 2 | 230,2 | T1 | #28/44 | Conduct Terminology Review |
| | | .1 .2 .3 .4 | | |
| 2 | 230,3 | T1 | #35/45 | Conduct Style Guide Review |
| | | .1 .2 .3 .4 | | |
| 2 | 235 | T1 or T2 | #52/46 | Performance Evaluation - Sum Up |
| | | .1 .2 .3 .4 | | |
| 2 | 240 | T2 or T1 | #29/47 | Debrief/Credits |
| | | .1 .2 .3 .4 | | |
| 2 | 250 | T2 or T1 | #38/48 | Lessons Learned from Simulation Game |
| | | .1 .2 .3 .4 | | |
| 2 | 260 | T1 or T2 | #37/49 | Corporate Usability Resources |
| | | .1 .2 .3 .4 | | |
| 2 | 270 | T2 orT1 | #41/50 | Knowledge Check |
| | | .1 .2 .3 .4 | | |
| 2 | 280 | T2 or T1 | #40/52 | Transfer of Knowledge Induction |
| | | .1 .2 .3 .4 | | |
| 2 | 290 | T2 or T1 | #39/51 | Workshop Evaluation |
| | | .1 .2 .3 .4 | | |

Detailed Description of Exemplary Learning Tasks

TABLE 2
Beginning of Workshop

| | |
|---|---|
| Sequence/No. | 10/#42 |
| Task Title | Introduction |
| Learning Objective | Establishing the Learning Setting - Group |
| | assessment: own position in common |
| | team picture |
| Location | Plenum-Room |
| Duration (Minutes) | 20 |
| Task Description | Prior to the course, 2 signboards with long |
| (Instruction) | title (doors of plenum and workshop rooms), |
| | distributing namebadges with given names or |
| | initials (Id#2) |
| | Welcome |
| | Introduction of Trainers |
| | Intro: Workshop Description; Organizational |
| | Matters; Corporate Culture |
| | Group Assessment: Learners' Roles at company, |
| | Use collect module from CPP 100 |

TABLE 3

| | |
|---|---|
| Sequence/No. | 20/#43 |
| Task Title | Learning Styles Self-Assessment |
| Learning Objectives | Message: People are different, you learners and |
| | users are even more different |
| | Styles actually mean actions at various phases: |
| | more than one type of action is needed (points |
| | to the advantages of team work of different, |
| | complementary people) |
| | Enable to reflect own expectancies |
| | Reflect own learning practice |
| Group/Role | All |
| Location | Plenum-Room |
| Participants (Min/Max) | All |
| Triggering Event | Id#42 |
| Duration (Minutes) | 40 |
| Task Description | Distribute questionnaire |
| (Instruction) | Fill out Self-Assessment Questionnaire |
| | Discussion of results (coordinate system with |
| | learning style preferences; Flipchart) |
| | Collect results: Learners stick dots on Flipchart |
| | Interpret results shortly in general; learners |
| | interpret own results |

TABLE 4

| | |
|---|---|
| Sequence/No. | 30/#44 |
| Task Title | Building Personas |
| Learning Objective | Get positive attitude towards User-Centered |
| | Development |
| | Activate (warm up) learners |
| | Experience cognitive effects of using personas |
| Group/Role | All |
| Location | Plenum-Room |
| Duration (Minutes) | 60 |
| Starting Time (relative) | End of introduction |
| Task Description | Moderated Exercise with entire group; use |
| (Instruction) | beamer projection to keep contact with learners |
| | Show web-site screen-shots on power point |
| | presentation (without Personas) |
| | Present a sample persona: John |
| | Exercise: build additional ad hoc persona from |
| | a picture and collect module from CPP 100 |
| | Walk through web-sites using Personas |
| | (keep persona pictures on screen) |
| Expected Results | Learners warmed up & having fun |
| Fallback Results | Trainers warmed up & having fun |

TABLE 5

| | |
|---|---|
| Sequence/No. | 40/#45 |
| Task Title | Value of Site Visits |
| Learning Objective | Accept principle: design from data; “I can do it, too” |
| Group/Role | All |
| Location | Plenum-Room |
| Duration (Minutes) | 20 |
| Task Description | Lecturette based on power point show |
| (Instruction) | |
| Expected Results | Learners accept method and stay curious |
| Notes | User research is important |
| | (basis for Task Force work - don't mention here!) |
| | User research begins with brainstorming |
| | User research starts with brainstorming, entering |
| | the Pizza scenario |
| | Fallback presentation |

Exemplary Simulation Game and Related Task Descriptions

TABLE 6

| | |
|---|---|
| Sequence/No. | 110/#01 |
| Task Title | Brainstorming, facilitated by trainers |
| Learning Objective | Experience cognitive effects of the technique |
| | Define Roles for Simulation game |
| Group/Role | Plenum |
| Location | Plenum-Room |
| Participants (Min/Max) | All |
| Triggering Event | Trainers |
| Duration (Minutes) | 30 |
| Task Description | Brainstorming conducted on flip chart |
| (Instruction) | Start out with manikin sketch |
| | After some minutes give the manikin a name |
| | and let learners experience the effects: |
| | Principle: use concrete persons with names |
| | Same with concrete variables in the setting |
| | (pizza baker has sticky fingers): |
| | Principle: use concrete environmental settings |
| | On question “Aren't we too specific?” It's |
| | more efficient do be specific - you can do |
| | several specific brainstorming |
| Expected Results | Learners know the technique and what's |
| | important when using it. 3 or more roles for |
| | Simulation Game are defined |
| | including: |
| | Consumer, |
| | Pizza Baker, |
| | Delivery Driver |
| Fallback Results | 3 roles: Consumer, Pizza Baker, |
| | Delivery Driver |
| Evaluation, Type of/ | Product: Complexity of diagram, |
| Credits | Coherence/consistency, overlap with master |
| | solution; relation to person |
| Notes | Fallback Use view module from CPP 100 |
| | mention that role of Pizza Baker may include |
| | aspects of role of “Pizza Operator” or |
| | “Pizza Manager” (T2) |

TABLE 7

| | |
|---|---|
| Sequence/No. | 120/#02 |
| Task Title | Splitting up (dividing) into small |
| | groups & rooms |
| Learning Objective | Not relevant |
| Group/Role | Trainers |
| Location | Plenum-Room, Workshop-Room |
| Participants (Min/Max) | All |
| Triggering Event | Trainers |
| Duration (Minutes) | 5 |
| Starting Time (relative) | After: Brainstorming in Plenum |
| Ending Time (relative) | +5 Min. |
| Task Description | Dividing into a minimum of 3 groups |
| (Instruction) | (“Prototyping Group”), wherein each group |
| | is defined by a role, such as, for example |
| | role 1 Consumer, |
| | role 2 Delivery Driver, |
| | role 3 Pizza Baker; |
| | Optionally, a further person is identified during |
| | brainstorming in the plenum (cf. dispatcher |
| | in table 35) A task force group is identified |
| | that - preferably - does not participate in |
| | brainstorming |
| | At the beginning of the course, learners |
| | sequentially receive name tags in random order. |
| | Each name tag carries a symbol (e.g., star, |
| | square, circle, triangle). This randomizes |
| | the distribution of learners to the required |
| | 4 groups (i.e., roles for group 1, role for group |
| | .2 and role for group .4 plus task force .3) |
| | Preferably, the distribution |
| | of symbols is equal to get groups of |
| | about equal size. |
| Expected Results | Exemplary Group Assignment (Overview): |
| | Star = Consumer − max. 6 learners |
| | Square = Deliver Driver − max. 6 learners |
| | Circle = Pizza Baker − max. 6 learners |
| | Triangle = Task Force − (˜14-18 learners) |
| Notes | Resources: Tags and pens |

TABLE 8

| | |
|---|---|
| Sequence/No. | 130,1/#04 (step 420) |
| Task Title | Brainstorming (group led) |
| Group/Role | Prototyping Group Consumer |
| Location | Workshop-Room |
| Participants (Min/Max) | Group “Consumer” |
| Triggering Event | Trainers/Splitting up into small groups |
| Duration (Minutes) | 30 |
| Starting Time (relative) | After Splitting up into small groups |
| Task Description | Previously, the learners performed |
| (Instruction) | brainstorming in the plenum and have |
| | identified important roles in the pizza service |
| | scenario. |
| | Now, the “Consumer” group focuses on |
| | the role of the consumer. |
| | Conduct a brainstorming session that focuses |
| | on a concrete consumer in a concrete situation. |
| | To start, this person is given a name, his/her |
| | location is defined, the time of day is define, |
| | his/her current actions etc. are defined |
| | The flip-chart is used to draw the brainstorming |
| | diagram. |
| | The learners find out where to learn more about |
| | the user's situation. |
| | A list with questions is created that |
| | the trainer hand to a team of researchers |
| | who will subsequently answer them. |
| Expected Results | A flip chart with the results of the |
| | brainstorming (diagram) |
| | A list with research questions for the |
| | Task Force |
| Fallback Results | A flip chart with the results of the |
| | brainstorming (diagram) |
| | A list with research questions for the Task |
| | Force |
| Evaluation, Type of/ | Product: Complexity of resulting diagram, |
| Credits | Coherence, Consistency, Overlap with Master |
| | Solution; Process: adherence to method as |
| | presented |

TABLE 9

| | |
|---|---|
| Sequence/No. | 130,2/#05 (step 420) |
| Task Title | Brainstorming (group led) |
| Learning Objective | |
| Group/Role | Prototyping Group Delivery Driver |
| Location | Workshop-Room |
| Participants (Min/Max) | Group “Delivery Driver” |
| Triggering Event | Trainers/Splitting up into small groups |
| Duration (Minutes) | 30 |
| Starting Time (relative) | After Splitting up into small groups |
| Task Description | Previously, the learners performed |
| (Instruction) | brainstorming in the plenum and have |
| | identified important roles in the pizza |
| | service scenario. |
| | Now, the “Delivery Driver”-group focuses on |
| | the role of the consumer. |
| | Conduct a brainstorming session that focuses |
| | on a concrete consumer in a concrete situation. |
| | To start, this person is given a name, his/her |
| | location is defined, the time of day is define, |
| | his/her current actions etc. are defined |
| | The flip-chart is used to draw the brainstorming |
| | diagram. |
| | The learners find out where to learn more about |
| | the user's situation. |
| | A list with questions is created that the trainer |
| | hand to a team of researchers who will |
| | subsequently answer them. |
| Expected Results | A flip chart with the results of the |
| | brainstorming (diagram) |
| | A list with research questions for the |
| | Task Force |
| Fallback Results | A flip chart with the results of the |
| | brainstorming (diagram) |
| | A list with research questions for the |
| | Task Force |
| Evaluation, Type of/ | Product: Complexity of resulting diagram, |
| Credits | Coherence, Consistency, Overlap with Master |
| | Solution; Process: adherence to method |
| | as presented |

TABLE 10

| | |
|---|---|
| Sequence/No. | 130,3/#06 (step 420) |
| Task Title | Brainstorming (group led) |
| Group/Role | Group “Pizza Baker” (i.e., group .4) |
| Location | Workshop-Room |
| Participants (Min/Max) | Group “Pizza Baker” |
| Triggering Event | Trainers/Splitting up into small groups |
| Duration (Minutes) | 30 |
| Starting Time (relative) | After Splitting up into small groups |
| Task Description | Previously, the learners performed |
| (Instruction) | brainstorming in the plenum and have |
| | identified important roles in the pizza |
| | service scenario. |
| | Now, the “Pizza Baker”-group focuses on the |
| | role of the consumer. |
| | Conduct a brainstorming session that focuses |
| | on a concrete consumer in a concrete situation. |
| | To start, this person is given a name, his/her |
| | location is defined, the time of day is define, |
| | his/her current actions etc. are defined |
| | The flip-chart is used to draw the |
| | brainstorming diagram. |
| | The learners find out where to learn more about |
| | the user's situation. |
| | A list with questions is created that the trainer |
| | hand to a team of researchers who will |
| | subsequently answer them. |
| Expected Results | A flip chart with the results of |
| | the brainstorming (diagram) |
| | A list with research questions for the |
| | Task Force |
| Fallback Results | A flip chart with the results of the |
| | brainstorming (diagram) |
| | A list with research questions for the |
| | Task Force |
| Evaluation, Type of/ | Product: Complexity of resulting diagram, |
| Credits | Coherence, Consistency, Overlap with |
| | Master Solution; Process: adherence to method |
| | as presented |

TABLE 11

| | |
|---|---|
| Sequence/No. | 130,4/#07 |
| Task Title | Brainstorming |
| Group/Role | Group .5 (e.g. “Dispatcher”), further group is |
| | the number of learners is large enough |
| Location | Workshop-Room |
| Participants (Min/Max) | Further Group (i.e., group (5)) |
| Triggering Event | Trainers/Splitting up into small groups |
| Duration (Minutes) | 30 |
| Starting Time (relative) | After Splitting up into small groups |
| Task Description | Previously was brainstorming method in the |
| (Instruction) | plenum. Important roles in the pizza service |
| | scenario had been identified. |
| | Conduct a brainstorming session which focuses |
| | on a concrete person in a concrete situation. |
| | To start, give this person a name, define |
| | where he/she is located, what the time of day |
| | is, what he/she is currently doing, etc. |
| | Use the flip-chart to draw the |
| | brainstorming diagram. |
| | Also, find out where you need to learn more |
| | about the user's situation. Create a list |
| | with questions you will hand to a team |
| | of researchers who will try to answer them. |
| Expected Results | A flip chart with the results of |
| | the brainstorming (diagram) |
| | A list with research questions for the |
| | Task Force |
| Fallback Results | A flip chart with the results of |
| | the brainstorming (diagram) |
| | A list with research questions for the |
| | Task Force |
| Evaluation, Type of/ | Reward (Ideas): Product: Complexity |
| Credits | of diagrams, Consistency, Matching to Sample |
| | Results; Process: Relation to Person |
| Notes | See Notes for Web Research Request |

TABLE 12

| | |
|---|---|
| Sequence/No. | 130,4/#56 |
| Task Title | Brief Task Force (i.e. group .3) |
| Learning Objective | Know the goals of task force |
| Group/Role | Trainer to task force |
| Location | Plenum |
| Participants (Min/Max) | All learners of task force |
| Triggering Event | Trainers, Id#2 |
| Duration (Minutes) | 5 |
| Starting Time (relative) | After Splitting up into small groups |
| Task Description | In order to create a usable product, |
| (Instruction) | development teams (i.e. groups .1.2.4) |
| | focus on their components. The task force |
| | keeps the big picture (keep the solution |
| | for the application together). The |
| | development teams (i.e. groups .1.2.4) |
| | need additional market & user information |
| | but have no time to collect it. |
| | The task force helps the learners |
| | by doing research in the web. Development |
| | teams (i.e. groups .1.2.4) need coordination |
| | regarding terminology and user interface |
| | standards. The task force (i.e. group .3) |
| | help them with terminology standards and style |
| | guide “golden rules” that are based on |
| | intranet & internet research. |

TABLE 13

| | |
|---|---|
| Sequence/No. | 130,5/#3 |
| Task Title | Receive Lecturette: Introduction to user |
| | environment design (i.e. reversed user |
| | environment of an example) |
| Learning Objective | Understand basic concepts of user |
| | environment design |
| Group/Role | Trainer to Task force (i.e., group .3) |
| Location | Plenum |
| Participants (Min/Max) | All learners of task force |
| Triggering Event | Trainers |
| Duration (Minutes) | 20 |
| Description | Learn what is a user environment. Enable the |
| | learners to answer questions like: Which user |
| | goals are supported? What can a user do? |
| | (concerning function). Where can the user go |
| | from here? (concerning links). What does the |
| | user manipulate? (concerning work objects). |
| | Use an example (a website/application by |
| | screenshots provided by trainers) to analyze |
| | an existing user environment. |
| Expected Results | Method: active listening, note taking |
| Evaluation, Type of/ | Applause (invited by trainers) |
| Credits | |

TABLE 14

| | |
|---|---|
| Sequence/No. | 140/#14 |
| Task Title | Reversed User Environment of Pizza Service |
| | in the Web (Consumer Perspective) |
| Learning Objective | To be able to contrast the user environments |
| | from the Prototyping Groups. Information |
| | flows back to the prototyping groups |
| | (i.e., .1.2.4) during prototyping No. 20 ff. |
| Group/Role | Task Force |
| Location | Plenum-Room |
| Participants (Min/Max) | 2/5. Large groups are split in two |
| Triggering Event | Trainers |
| Duration (Minutes) | 60 |
| Task Description | Visit a commercial website |
| (Instruction) | Use the demo for a reverse user environment |
| | design. |
| | For every page, list: |
| | The purpose: Which user goals are supported? |
| | The functions: What can a user do? |
| | The links: Where can the user go from here? |
| | The work objects: What does the user |
| | manipulate? |
| | Write the findings of your analysis on one |
| | sheet of paper for each web page (templates |
| | are provided). Arrange these sheets of paper |
| | on a pin-board and visualize the connections |
| | between them. Write a “lessons learned” |
| | statement to communicate your findings to the |
| | development groups. |
| | Use the corresponding template provided in |
| | CPP 100 form module. Trainer T1: Appoint 2 |
| | presenters (see Id#32) |
| | Trainer T2: Rate performance. (see Id#57) |
| Expected Results | User environment on pin-board, “lessons |
| | learned” statement; both to be communicated |
| | to prototyping group “Consumer” |
| | (i.e., group .1) |

TABLE 15

| | |
|---|---|
| Sequence/No. | 150/#08 |
| Task Title | Pose Web Research Request |
| Group/Role | Task Force (i.e. group .3) |
| Location | Workshop-Room |
| Triggering Event | Brainstorming group poses task |
| | description (provided by trainers) to Task Force |
| Duration (Minutes) | 10 |
| Task Description | These are the results of our brainstorming. |
| (Instruction) | We still need to clarify 1. 2. 3. |
| | Please run a web (re-)search and investigate |
| Fallback Results | See Id#33 |
| Notes | To do: |
| | Do feasibility check! (Input for check: pilot |
| | brainstorming) |
| | Complete Provide hints for answering the questions |
| | Resources: To be specified |

TABLE 16

| | |
|---|---|
| Sequence/No. | 155/#47 |
| Task Title | Performance evaluation of brainstorming (i.e. results |
| | concerning step 420) |
| Group/Role | Trainer on development teams |
| | (i.e. trainer of groups .1.2.4) |
| Location | Workshop-Room |
| Task Description | Evaluate learners performance Id#04-06 (i.e. of step |
| (Instruction) | 420) |

TABLE 17

| | |
|---|---|
| Sequence/No. | 160,1/#09 |
| Task Title | Receive Lecturette Introduction into |
| | User Environment Design |
| Learning Objective | Understand basic concepts of user environment |
| | design. |
| Group/Role | Presenters from task force to |
| | development groups, |
| Location | Workshop-Room |
| Participants (Min/Max) | All |
| Triggering Event | Trainers/various |
| Duration (Minutes) | 20 |
| Starting Time (relative) | After: various |
| Task Description | Method: Active Listening, Note Taking |
| (Instruction) | |
| Fallback Results | Trainers |
| Evaluation, Type of/ | Applause (invited by trainers) |
| Credits | |

TABLE 18

| | |
|---|---|
| Sequence/No. | 160,2/#31 |
| Task Title | Give lecturette into user environment design |
| Learning Objective | Teach back basic concepts of user environment |
| | design. |
| Group/Role | Task force (preferably, 2 learners out of this |
| | group) |
| Location | Plenum-Room |
| Participants (Min/Max) | 2 |
| Triggering Event | Trainers/various |
| Duration (Minutes) | 20 |
| Task Description | Method: lecturette |
| (Instruction) | Contents: Give examples: |
| | The purpose: Which user goals are supported? |
| | The functions: What can a user do? |
| | The links: Where can the user go from here? |
| | The work objects: What does the user |
| | manipulate? |
| Fallback Results | Trainers (provide lecturette) |
| Evaluation, Type of/ | Applause (invited by trainers) |
| Credits | |

TABLE 19

| | |
|---|---|
| Sequence/No. | 160,3/#33 |
| Task Title | Modify Web Research Request |
| Group/Role | Trainers |
| Location | Plenum-Room |
| Participants (Min/Max) | Trainers |
| Triggering Event | Id#08 Id#8 Pose Web Research Request |
| Duration (Minutes) | 15 = 3 * 5 Min. |
| Task Description | Compare prepared Web Research Tasks with |
| (Instruction) | tasks prepared by the brainstormers |
| | (i.e., groups .1.2.4). |
| | Add prepared “Must” tasks from trainers' list. |
| | Delete superfluous tasks from brainstormers' |
| | list. Rephrase tasks from brainstormers' list. |
| | Hand out the resulting task list(s) to members |
| | of Task Force (i.e., group .3). |
| Expected Results | Task list(s) - question list |
| Notes | Define “Must” Web Research Tasks |
| | Decide whether the Task Force will receive |
| | only one list (resulting in same answers for |
| | each of the Working Groups, or a separate list |
| | for each Working Group) Resources: Input |
| | from Development Groups (i.e., group |
| | .1.2.4). Use template from CPP 100 |

TABLE 20

| | |
|---|---|
| Sequence/No. | 170,1/#10 |
| Task Title | User Environment Design (group led) |
| Group/Role | Prototyping Group Consumer - (i.e., group. 1) |
| Location | Workshop-Room |
| Participants (Min/Max) | Group “Consumer” - group .1 |
| Triggering Event | Trainers/Lecturette Introduction into User |
| | Environment Design |
| Duration (Minutes) | 60 |
| Starting Time (relative) | After Lecturette Introduction into User |
| | Environment Design |
| Task Description | The “Consumer” group (i.e., group .1) - |
| (Instruction) | is expected to perform a User Environment |
| | Design as it has been presented in the |
| | Lecturette on this same technique. |
| | The learners are asked to fill out the templates |
| | provided by us and arrange them on the pin |
| | board. This arrangement should reflect the User |
| | Environment Design for the User Interface. |
| | Test the User Environment Design with the |
| | previous results from your brainstorming. |
| | In addition, the learners need the User |
| | Environment Design in the following. |
| Expected Results | A pin board with the results of the User |
| | Environment Design |
| Fallback Results | Use view module from CPP 100 with a |
| | standard User Environment Design |

TABLE 21

| | |
|---|---|
| Sequence/No. | 170,2/#11 |
| Task Title | User Environment Design (group led) |
| Learning Objective | |
| Group/Role | Group .2 “Delivery Driver” |
| Location | Workshop-Room |
| Participants (Min/Max) | Group .2 “Delivery Driver” |
| Triggering Event | Trainers/Lecturette Introduction into |
| | User Environment Design |
| Duration (Minutes) | 60 |
| Starting Time (relative) | After Lecturette Introduction into |
| | User Environment Design |
| Ending Time (relative) | |
| Task Description | The “Delivery Driver” (i.e., group .2) is |
| (Instruction)h | expected to perform a User |
| | Environment Design as it has been presented |
| | in the Lecturette on this same technique. |
| | The learners are asked to fill out the templates |
| | provided by us and arrange them on the pin |
| | board. This arrangement should reflect the User |
| | Environment Design for the User Interface. |
| | Test the User Environment Design with the |
| | previous results from your brainstorming. |
| | In addition, the learners need the User |
| | Environment Design in the following. |
| Expected Results | A pin board with the results of the |
| | User Environment Design |
| Fallback Results | Use view module from CPP 100 with a |
| | standard User Environment Design |

TABLE 22

| | |
|---|---|
| Sequence/No. | 170,3/#12 |
| Task Title | User Environment Design (group led) |
| Learning Objective | |
| Group/Role | Group “Pizza Baker” - group .4 |
| Location | Workshop-Room |
| Participants (Min/Max) | Group “Pizza Baker” - group .4 |
| Triggering Event | Trainers/Lecturette Introduction into |
| | User Environment Design |
| Duration (Minutes) | 60 |
| Starting Time (relative) | After Lecturette Introduction into |
| | User Environment Design |
| Ending Time (relative) | |
| Task Description | The “Pizza Baker” (i.e., group .4) is expected |
| (Instruction) | to perform a User Environment Design as it |
| | has been presented in the Lecturette on this |
| | same technique. |
| | The learners are asked to fill out the templates |
| | provided by us and arrange them on the pin |
| | board. This arrangement should reflect the User |
| | Environment Design for the User Interface. |
| | Test the User Environment Design with the |
| | previous results from your brainstorming. |
| | In addition, the learners need the User |
| | Environment Design in the following. |
| Expected Results | A pin board with the results of the |
| | User Environment Design |
| Fallback Results | Use view module from CPP 100 with a |
| | standard User Environment Design |

TABLE 23

| | |
|---|---|
| Sequence/No. | 180,1/#36 |
| Task Title | Prepare Tasks for Usability Tests |
| Group/Role | Trainers |
| Duration (Minutes) | 60 |
| Expected Results | Task Descriptions: Scenario + Task description |
| | (“You are . . . , your task is”) |
| Fallback Results | Task Descriptions from last course |
| Notes | Use results from Brainstorming and all existing |
| | specifications that have been worked |
| | out by the groups (also Task Force .3 requirements). |

TABLE 24

| | |
|---|---|
| Sequence/No. | 180,2/#30 |
| Task Title | Organize Task Force |
| Group/Role | Trainers/Task Force (i.e, group .3) |
| Location | Plenum-Room |
| Triggering Event | Task Force receives task description (prepared by |
| | trainers) from Brainstorming Group |
| Duration (Minutes) | 10 |
| Task Description | Trainers: Split up the Task Force into 2 large teams: |
| (Instruction) | (3-1) Style Guide Research (3 tandems with 2 |
| | members each) for Id#34 |
| | (3-2) the remaining members into Web Research |
| | Team for Id#15 |
| | Tell the teams (3-1)(3-2) that this setup is valid for |
| | the next hour and that the task assignment will be |
| | changed after this. |
| | Give instructions according to following tasks. |

TABLE 25

| | |
|---|---|
| Sequence/No. | 190,1/#15 |
| Task Title | Conduct Web Research: Pizza Service in the Web 1 |
| | (addressing all Development Groups .1.2.4) |
| Learning Objective | See the trade-off between preparing attractive |
| | presentations and the requirements of developers |
| | to get educated; perspective of PM; experience |
| | value of this activity, how difficult it is to |
| | communicate to developers |
| Group/Role | Task Force Team (self-organized) (i.e., group .3) |
| Location | Plenum-Room |
| Participants | 2/8 |
| (Min/Max) | |
| Triggering Event | Trainers |
| Duration (Minutes) | 40 |
| Task Description | General Instruction |
| (Instruction) | Remember: importance of user research (site |
| | visits are one method, web research is another) |
| | (I). What do you learn from some of these web |
| | sites (or pages) in terms of the motivations and |
| | expectations, needs and goals of consumers, |
| | delivery drivers, or pizza bakers, respectively? |
| | What are the implications for the design of the |
| | solutions? Create a presentation of your findings |
| | and communicate it to the respective |
| | Development Group .1.2 or .4. |
| | (II). You will also get specific questions that you |
| | should investigate. Communicate the results |
| | back to the Development Group as fast as |
| | possible, giving first the Chairs a copy of each |
| | result (one after one: research one question, |
| | then communicate back, then research the next |
| | question). |
| | Additional Hints: Use the templates provided in |
| | CPP 100 Form Module to write down your |
| | answers and print them out for further |
| | communication. |
| | Trainer: Rate performance (see Id#29) |
| Expected Results | Work practice findings on flip-chart or other media, |
| | such as view module from CPP 100 |

TABLE 26

| | |
|---|---|
| Sequence/No. | 190,2/#34 |
| Task Title | Style Guide Research |
| Learning Objective | Experience value of this activity, how difficult it |
| | is to communicate to developers |
| Group/Role | Task Force (i.e., group .3) - cf. #24, table 24, |
| | team (3-1) |
| Location | Plenum-Room |
| Participants | min. 6 members (to create 3 subteams of 2 or more |
| (Min/Max) | members each) |
| Triggering Event | End of Id#30 Receive Web Research |
| | request/Trainers |
| Duration (Minutes) | 60 |
| Starting Time | End of Id#30 Receive Web Research request |
| (relative) | |
| Task Description | See instruction handout: Id#34 |
| (Instruction) | Style Guide Rules are presented to groups .1.2.4 |
| | Timing: results should be ready shortly before |
| | development teams start prototyping |
| | Trainer: rate Performance! (see Id#29) |
| Expected Results | 3 sheets of paper with 10 rules each for |
| | screen layout |
| | navigation within the application |
| | placement of fields & functions |
| | user support by text, messages etc. |
| Notes | Style Guide Research Team, divided in 3 Subteams |
| | (according to 3 Development Groups); |
| | Subteams must coordinate whenever a |
| | Style Guide rule is concerned or multiple |
| | development groups (i.e., groups .1.2.4) are |
| | involved. Resources: Corporate Usability Resources |
| | Example: company User Interface |
| | Design Guidelines, containing |
| | (available on the company intranet) |

TABLE 27

| | |
|---|---|
| Sequence/No. | 190,6/#57 |
| Task Title | Performance Evaluation of reverse user environment |
| Group/Role | Trainer on Task Force (i.e., group .3) |
| Location | Plenum-Room |
| Participants | Trainer |
| (Min/Max) | |
| Triggering Event | (time available) |
| Duration (Minutes) | 5 |
| Task Description | Evaluate pinboard diagrams with reverse UE |
| (Instruction) | |
| Expected Results | Performance rating |
| Fallback Results | None |
| Evaluation, Type of/ | See Rating Sheet |
| Credits | |

TABLE 28

| | |
|---|---|
| Sequence/No. | 195/#48 |
| Task Title | Performance Evaluation: User Environment Design |
| Group/Role | Trainer on development groups (i.e., groups .1.2.4) |
| Location | Workshop-Room |
| Task Description | Evaluate learner performance Id#10-12 |
| (Instruction) | Use summary sheet in CPP 100 Forms Module |

TABLE 29

| | |
|---|---|
| Sequence/No. | 200/#32 |
| Task Title | Communicate Reverse user environment to |
| | development Group “Consumer” (i.e., group .1) |
| Learning | Experience communication difficulties |
| Objective | |
| Group/Role | Learners-group “consumers” (i.e., group .2) |
| Location | Workshop-Room |
| Participants | 2 Task Force Members out of group doing task Id#15 |
| (Min/Max) | Web Research |
| Triggering Event | Trainers. Development group doing task 13 User |
| | Environment Design must be well under way |
| Duration | 20 |
| (Minutes) | |
| Task Description | Instruction to learners: |
| (Instruction) | Your group has prepared a reverse user environment of |
| | a pizza service website. Communicate the results to the |
| | group who is preparing a paper prototype for the |
| | consumer website: |
| | present the reverse user environment |
| | write a “lessons learned” paper |
| Notes | Development group doing Task 13 User Environment |

TABLE 30

| | |
|---|---|
| Sequence/No. | 210/#19 |
| Task Title | Lecturette Introduction into Paper Prototyping |
| Learning Objective | Enable the learners to start applying |
| | paper prototyping: |
| | How to simulate interface elements on paper, |
| | why, how to role play the interaction process, |
| | get to see examples from pictures |
| | or real mock-ups |
| Group/Role | Trainers |
| Location | Plenum-Room |
| Participants (Min/Max) | All (check: to include Task Force or not) |
| Triggering Event | Trainers/various |
| Duration (Minutes) | 20 |
| Starting Time (relative) | After: User Environment Design |
| Task Description | Method: Lecturette |
| (Instruction) | |

TABLE 31

| | |
|---|---|
| Sequence/No. | 215/#54 |
| Task Title | Organize Task Force 2 |
| Group/Role | Trainers/Task Force 2 (i.e., group .3) |
| Location | Plenum-Room |
| Triggering Event | Task Force receives task description (prepared by |
| | trainers) from Brainstorming Group |
| Duration (Minutes) | 10 |
| Task Description | Trainers: Split up the task force (i.e., group .3) |
| (Instruction) | into three large teams: |
| | 1. Terminology Research User Interface (UI) Id#16 |
| | (half of former web research team) - group (3-1) |
| | 2. Terminology Research Content Id#17 |
| | (half of former web research team) - group (3-2) |
| | 3. Web Research Team Id#53 (was: style guide |
| | research team) (group 3-3) |
| | Give instructions according to respective tasks |
| Notes | As prepared by the brainstorming groups and |
| | modified by trainers |

TABLE 32

| | |
|---|---|
| Sequence/No. | 220,0/#53 |
| Task Title | Conduct web search: pizza service in the web |
| | (addressing all development groups .1.2.4) |
| Learning Objective | Experience the trade-off between preparing |
| | attractive presentations and the requirements of |
| | developers to get educated; perspective of PM; |
| | Experience value of this activity, how difficult it is |
| | to communicate to developers |
| Group/Role | Task Force Team (self-organized) - group .3 |
| Location | Plenum-Room |
| Participants | 2/8 |
| (Min/Max) | |
| Triggering Event | Trainers |
| Duration (Minutes) | 80 |
| Task Description | General Instruction |
| (Instruction) | What do you learn from some of these web sites |
| | (or pages) in terms of the motivations and |
| | expectations, needs and goals of consumers, |
| | delivery drivers, or pizza bakers, respectively? |
| | What are the implications for the design of the |
| | solutions? Create a presentation of your findings |
| | and communicate it to the respective |
| | Development Group .1.2.4. |
| | You will also get specific questions that you |
| | should investigate. Communicate the results back |
| | to the Development Group as fast as possible, |
| | giving first the Chairs a copy of each result (one |
| | after one: research one question, then |
| | communicate back, then research the next |
| | question). |
| | Additional Hints |
| | Use templates provided in CPP 100 Forms |
| | Module to write down your answers and print |
| | them out for further communication. |
| | Trainer: Rate performance! (see Id#29) |
| Expected Results | Work practice findings on flip-chart or other |
| | media, such as view module from CPP 100 |
| Notes | See Id#15 (same task prior in sequence) |
| | s. sequence 220,1 Id#46 |

TABLE 33

| | |
|---|---|
| Sequence/No. | 220,1/#46 |
| Task Title | Communicate Web Research |
| Group/Role | Task Force Teams (i.e., group .3) |
| Location | Workshop-Room |
| Task Description | Communicate the results to the development groups |
| (Instruction) | .1.2.4, answering each question as fast as possible, in |
| | sequence (first finish one answer, then communicate, |
| | then continue with next question) |
| Notes | See 190,1/Id#15 |
| | Resources: Use form module from CPP 100 |

TABLE 34

| | |
|---|---|
| Sequence/No. | 220,2 #16 |
| Task Title | Terminology: User Interface |
| Learning Objective | Experience value of this activity, how difficult it is |
| | to communicate to developers Consistent names are |
| | supported by professional tools (ad hoc names |
| | could be detrimental) Corporate terminology |
| | support tools, e.g. term database |
| Group/Role | Task Force (i.e. group .3) |
| Location | Plenum-Room |
| Participants | 2-2 |
| (Min/Max) | |
| Triggering Event | Some Prototypes have been built already/Trainers |
| Duration (Minutes) | 60 |
| Starting Time | Ca. 60 after prototypers have started |
| (relative) | |
| Task Description | Make sure that the solutions use consistent |
| (Instruction) | terminology. |
| | Interface elements: |
| | Research which elements are used by the |
| | development groups (i.e., group .1.2.4), how do |
| | the developers call them, which interface |
| | elements have no names (yet), how are the |
| | interface elements commonly called at your |
| | company |
| | Analysis of findings and decision-making |
| | Decide how the various interface elements should |
| | be referred to consistently in the groups. |
| | Communicate how the various interface elements |
| | should be referred to in the groups. |
| | Trainer: rate Performance! (see Id#29) |
| Expected Results | Glossary (terms and explanations) on paper |
| | (print out) |
| Fallback Results | Glossary (provided by trainers) |
| Evaluation, | Research/Analysis: Matching with Fallback |
| Type of/Credits | Solution; User of proper tools |
| | (corporate terminology guidelines); |
| | Communication: peer rating by prototype developers |
| | (did you use this glossary? how useful was it?); |
| | Rating Scale 1-5 (1 = of little use, 5 = must use it) |
| Notes | Use form module from CPP 100 |

TABLE 35

| | |
|---|---|
| Sequence/No. | 220,3/#17 |
| Task Title | Terminology: Content |
| Learning Objective | Experience value of this activity, how difficult it is |
| | to communicate to developers |
| Group/Role | Task Force (i.e., group .3) |
| Location | Plenum-Room |
| Task Description | Make sure that the solutions use consistent |
| (Instruction) | terminology. Create a Dictionary on paper |
| | (use print module from CPP 100): Product Names: |
| | 12 different types of pizza (Italian and |
| | Course Language), e.g. Marguerita, not Margerita |
| | Roles: consumer, delivery driver, baker or |
| | dispatcher (Course Language) Measurement Units: |
| | all units used (Course Language) |
| | 1. Research - Which terms are used by the |
| | groups .1.2.4 Which objects have no names (yet) |
| | 2. Analysis of findings and decision-making. |
| | Decide how the various objects should be referred |
| | to consistently in the prototyping groups. |
| | 3. Communicate how the various objects should be |
| | referred to in the prototyping groups. |
| | Trainer: Rate performance! (see Id#29) |
| Expected Results | To do: List of pizzas etc. (T2) |
| Fallback Results | Dictionary (provided by trainers) |
| Evaluation, | (a) No. Of correctly spelled pizzas, (b) percentage of |
| Type of/Credits | correctly used terms |
| Notes | Use view module from CPP 100 |

TABLE 36

| | |
|---|---|
| Sequence/No. | 220,4/#20 |
| Task Title | Paper Prototyping (group led) |
| Learning Objective | Experience value of this activity, practice technique |
| Group/Role | Development Group “Consumer” |
| Location | Workshop-Room |
| Participants | Group “Consumer” - group .1 |
| (Min/Max) | |
| Triggering Event | Trainers/Lecturette Introduction into |
| | Paper Prototyping |
| Duration (Minutes) | 30 |
| Starting Time | After Lecturette Introduction into Paper Prototyping |
| (relative) | |
| Task Description | The “Consumer” group (i.e., group .1) is now |
| (Instruction) | expected to build a paper prototype. |
| Expected Results | A paper prototype |

TABLE 37

| | |
|---|---|
| Sequence/No. | 220,5/#21 |
| Task Title | Paper Prototyping (group led) |
| Learning Objective | Experience value of this activity, practice technique |
| Group/Role | Development Group “Delivery Driver” |
| | (i.e., group .2) |
| Location | Workshop-Room |
| Participants | Group “Delivery Driver” (i.e., group .2) |
| (Min/Max) | |
| Triggering Event | Trainers/Lecturette Introduction into |
| | Paper Prototyping |
| Duration (Minutes) | 30 |
| Starting Time | After Lecturette Introduction into Paper Prototyping |
| (relative) | |
| Task Description | See Id#20 |
| (Instruction) | |
| Expected Results | See Id#20 |

TABLE 38

| | |
|---|---|
| Sequence/No. | 220,6/#22 |
| Task Title | Paper Prototyping (group led) |
| Learning Objective | Experience value of this activity, practice |
| | technique |
| Group/Role | Group “Pizza Baker” (i.e., group .4) |
| Location | Workshop-Room |
| Participants (Min/Max) | Group “Pizza Baker” (i.e., group .4) |
| Triggering Event | Trainers/Lecturette Introduction into Paper |
| | Prototyping |
| Duration (Minutes) | 30 |
| Starting Time (relative) | After Lecturette Introduction into Paper |
| | Prototyping |
| Ending Time (relative) | See Id#20 |
| Task Description | See Id#20 |
| (Instruction) | |
| Expected Results | See Id#20 |

TABLE 39

| | |
|---|---|
| Sequence/No. | 225,1/#49 |
| Task Title | Performance Evaluation: Terminology Research |
| Group/Role | Trainer on Task Force (i.e., group .3) |
| Location | Plenum-Room |
| Task Description | Evaluate learner performance Id#16/#17, trainers take |
| (Instruction) | research results home, use evaluation sheets (CPP100 |
| | Form Module) in folder Id#49-51 Performance |
| | Evaluation Task Force |

TABLE 40

| | |
|---|---|
| Sequence/No. | 225,2/#50 |
| Task Title | Performance Evaluation: Style Guide Research |
| Group/Role | Trainer on Task Force (i.e., group .3) |
| Location | Plenum-Room |
| Task Description | Evaluate learner performance Id#34 |
| (Instruction) | trainers take research results home |
| | use evaluation sheets (CPP100 Form Module) in folder |
| | Id#49-51 Performance Evaluation Task Force |

TABLE 41

| | |
|---|---|
| Sequence/No. | 225,3/#51 |
| Task Title | Performance Evaluation: Web Research |
| Group/Role | Trainer on Task Force (i.e., group .3) |
| Location | Plenum-Room |
| Task Description | Evaluate learner performance Id#15, 53, trainers take |
| (Instruction) | research results home, use evaluation sheets (CPP100 |
| | Form Module) in folder Id#49-51 Performance |
| | Evaluation Task Force |

TABLE 42

| | |
|---|---|
| Sequence/No. | 221/#55 |
| Task Title | Briefing Test & Reviews |
| Learning Objective | Split up in groups/assign roles for Id#24 |
| | Usability Test and Id#28/35 Terminology/Style |
| | Guide Review |
| Group/Role | Trainers to all |
| Location | Plenum-Room |
| Participants (Min/Max) | All |
| Duration (Minutes) | 10 max |
| Task Description | See instruction sheet: Id#55 |
| (Instruction) | |

TABLE 43

| | |
|---|---|
| Sequence/No. | 230,1/#24 |
| Task Title | Prototype Usability Test |
| Location | Workshop-Room |
| Triggering Event | Id#36 |
| Task Description | Test paper prototypes using task descriptions Id#36 |
| (Instruction) | |

TABLE 44

| | |
|---|---|
| Sequence/ | 230,2/#28 |
| No. | |
| Task Title | Conduct Terminology Review |
| Learning | Experience effectiveness (or lack thereof) of a |
| Objective | guideline/review system |
| Group/Role | development groups .1.2.4 with Task Force .3 Teams |
| | (Terminology subteam). |
| Location | Workshop-Room |
| Task | You submitted terminology guidelines to the development |
| Description | teams. Now it's time to check whether the various |
| (Instruction) | prototypes comply with those guidelines. |
| | Take the guidelines paper you submitted to the group you |
| | worked for. |
| | For each guideline submitted, check whether it was fulfilled |
| | or not. |
| | Discuss your findings with the development team. |
| | Meet the Simulation game Chair to report your results. |

TABLE 45

| | |
|---|---|
| Sequence/ | 230,3/#35 |
| No. | |
| Task Title | Conduct style guide review |
| Learning | Experience effectiveness (or lack thereof) of a |
| Objective | guideline/review system |
| Group/Role | Development groups with task force teams |
| | (style guide subteam) |
| Location | Workshop-Room |
| Task | You submitted usability/interaction design guidelines to the |
| Description | development teams. Now it's time to check whether the |
| (Instruction) | various prototypes comply with those guidelines. |
| | Take the guidelines paper you submitted to the group you |
| | worked for. For each guideline submitted, check whether it |
| | was fulfilled or not. Discuss your findings with the |
| | development team. Meet the simulation game chair to |
| | report your results. |

TABLE 46

| | |
|---|---|
| Sequence/No. | 235/#52 |
| Task Title | Performance Evaluation - Sum Up |
| Group/Role | Trainer on all |
| Location | Plenum-Room |
| Task Description | Tally learner performance |
| (Instruction) | |

TABLE 47

| | |
|---|---|
| Sequence/ | 240/#29 |
| No. | |
| Task Title | Debrief/ Credits |
| Group/Role | Trainers |
| Location | Plenum-Room |
| Triggering | Id#24, Id#28, Id#35 |
| Event | |
| Task | Presentation of Results from Tests and Reviews |
| Description | Highlights, Scoring: see evaluation sheet Id#29 |
| (Instruction) | Final Scoring “. . . and the winner is . . .” + Presents for the |
| | Winners |
| Evaluation, | Results from Tests Id#24 & Reviews Id#28 / Id#35 - |
| Type of/ | Product Evaluation:, Task Completion (e.g., Prototype |
| Credits | Usability Test; User Satisfaction), Compliance with Rules |
| | (e.g., Style Guide & Terminology Rules) |

TABLE 48

| | |
|---|---|
| Sequence/ | 250/#38 |
| No. | |
| Task Title | Lessons Learned from Simulation Game |
| Learning | Stress-Release |
| Objective | Trainers get feedback |
| | Intensify learning experience by reflecting |
| | (learners self-assurance |
| Location | Plenum-Room |
| Participants | All |
| (Min/Max) | |
| Triggering | Id#29 |
| Event | |
| Duration | 60 |
| (Minutes) | |
| Task | (1) Survey using cards “what I liked/disliked”: |
| Description | About me |
| (Instruction) | About my team |
| | About the tasks (simulation game) |
| | (2) Plenum survey/discussion: ROI - What I learned/didn't |
| | learn (pen&poker-Principle), |
| | Contributors indicate their group in the sim game! |
| | Use collect module from CPP 100 to Collect results |
| | (visualize on projector, optionally: Print module from CPP |
| | 100) |

TABLE 49

| | |
|---|---|
| Sequence/No. | 260/#37 |
| Task Title | Usability Resources |
| Location | Plenum-Room |
| Participants (Min/Max) | All |
| Triggering Event | Id#38 over |
| Duration (Minutes) | 120 |
| Task Description | See instruction sheet Id#37 |
| (Instruction) | (Outline: combine user day “light usability |
| | testing” method with search tasks within |
| | corporate intranet resources (such as style |
| | guides,methodology documentation, contacts) |
| Fallback Results | Link to our Usability Resources Homepage |

TABLE 50

| | |
|---|---|
| Sequence/ | 270/#41 |
| No. | |
| Task Title | Self-assurance of knowledge gained |
| Location | Plenum-room or workshop-room |
| Notes | Participants should: a) Assign concepts (that they have |
| | learned in the simulation) to a selection of explanations; b) |
| | bring into the correct order. Learner could test themselves |
| | how many answers where correct. Understanding of core |
| | concept. |

TABLE 51

| | |
|---|---|
| Sequence/ | 290/#39 |
| No. | |
| Task Title | Workshop evaluation |
| Task | Write informal comments —CPP 100 Form Module |
| Description | (demonstrate): Participants state whether they want to |
| (Instruction) | receive a consolidated survey feedback some weeks later |
| | (triggering reconsideration of learning effects after some |
| | work practice). |

TABLE 52

| | |
|---|---|
| Sequence/ | 280/#40 |
| No | |
| Task Title | Transfer of Knowledge Induction |
| Notes | Transfer: Form small groups (tandems). |
| | Participants formulate 2-3 insights and intentions, what to |
| | do about them in the future (new/different behavior). |
| | For every intention find 1-2 obstacles or threats to the |
| | implementation. |
| | For every threat/obstacle 1-2 solution approaches |
| | realize that a 2 day course can just be the beginning of |
| | mind/practice change, realize importance of social |
| | cooperation. |
| | Learning Contract with buddies, stating |
| | intentions/problems/solutions, triggering organization of |
| | follow-up meetings. |
| | Variant: write a mail to yourself, containing |
| | intentions/problems/solutions, to be delivered in 6 months. |

Other embodiments of the invention will be apparent to those skilled in the art from consideration of the specification and practice of the embodiments of the invention disclosed herein. In addition, the invention is not limited to the particulars of the embodiments disclosed herein. For example, the individual features of each of the disclosed embodiments may be combined or added to the features of other embodiments. In addition, the steps of the disclosed methods herein may be combined, modified or re-ordered without departing from the spirit of the invention. Accordingly, it is intended that the specification and embodiments disclosed herein be considered as exemplary only.

What is claimed:

1. A method for training a plurality of learners to develop user interfaces for a software application that interact with a plurality of users, including a first user and a second user, the method comprising:
dividing the plurality of learners into a first group, a second group and a third group;
brainstorming, by the first group and the second group, to generate an overall usage context for the user interfaces;
designing, by the first group and the second group, first and second usage scenarios;
providing, by the first group and the second group, first and second prototypes for the user interfaces according to the first and second usage scenarios, respectively; and
analyzing, by the third group and in parallel to at least designing, existing user interfaces to provide assistance to the first and second groups in providing the prototypes.

2. The method of claim 1, further comprising performing, prior to dividing and brainstorming, an introduction for the learners.

3. The method of claim 2, wherein performing an introduction comprises self-assessing a learning style by the learners.

4. The method of claim 3, wherein self-assessing a learning style is performed by substantially all learners in the plurality of learners.

5. The method of claim 4, wherein self-assessing a learning style comprises tasking the learners to respond to a predefined questionnaire.

6. The method of claim 4, wherein self-assessing a learning styles comprises tasking the learners to stick dots to a flipchart with a coordinate system, wherein the dots anonymously represent the responses to the questionnaire and wherein the dots are visible to the plurality of learners.

7. The method of claim 2, wherein performing an introduction comprises building personas.

8. The method of claim 7, wherein building personas comprises tasking the learners to perform an exercise that is moderated by a trainer.

9. The method of claim 8, wherein performing the moderated exercise comprises presenting a public website without persona, presenting a sample persona, preparing ad hoc a persona from a picture, navigating through web sites using the persona and collecting feedback from the learners.

10. The method of claim 1, wherein performing an introduction comprises providing a slide show presentation relating to the value of site visits.

11. The method of claim 1, wherein dividing is performed by using random techniques.

12. The method of claim 11, wherein dividing is performed by randomly distributing tags with symbols to substantially all learners, wherein the number of different symbols on the tags corresponds to the number of groups.

13. The method of claim 12, wherein dividing is performed using symbols selected from the group of: a star, a square, a circle, and a triangle.

14. The method of claim 1, further comprising performing initial brainstorming, wherein initial brainstorming is performed by all learners prior to dividing.

15. The method of claim 14, wherein performing initial brainstorming comprises using a flip chart, providing a manikin sketch on the flip chart, giving the manikin a name and letting the learners experience the effects.

16. The method of claim 15, wherein letting the learners experience the effects comprises using concrete environmental settings.

17. The method of claim 1, further comprising enabling the learners to identify important roles in the first and second usage scenarios.

18. The method of claim 1, wherein brainstorming comprises focusing on the role of one of the users of the first and second usage scenarios, respectively.

19. The method of claim 18, wherein focusing on the role of one of the users comprises defining a usage context with a location of one of the users, an estimated time of day and an estimated set of current actions by the user.

20. The method of claim 18, wherein brainstorming comprises drawing a brainstorming diagram.

21. The method of claim 18, wherein brainstorming comprises creating a list of questions for the third group.

22. The method of claim 21, wherein the list of questions is handed over to the third group by trainers who optionally modify the list.

23. The method of claim 1, wherein analyzing comprises tasking the third group to search in predetermined resources, wherein the search is based on the performance of brainstorming by the first and second groups.

24. The method of claim 23, wherein the predetermined resources are selected from the group of: hand-outs, interviews of people outside the plurality of learners, and publicly accessible information.

25. The method of claim 1, wherein analyzing by the third group comprises tasking a first team of the third group to do style guide research and tasking a second team of the third group to do web research.

26. The method of claim 1, further comprising presenting, subsequent to brainstorming and prior to designing, a lecturette to the learners of the first and second groups as an introduction into user environment design.

27. The method of claim 1, further comprising presenting, prior to analyzing, a lecturette to the learners of the third group as an introduction into user environment design.

28. The method of claim 27, wherein presenting the lecturette comprises presenting the lecturette to an audience of only some members of the third group.

29. The method of claim 1, wherein designing comprises tasking the learners of the first and second groups to fill out templates and arrange the templates on a pin board.

30. The method of claim 29, wherein the templates on the pin board reflect the first and second usage scenarios for the user interface.

31. The method of claim 30, wherein designing further comprises testing the usage scenarios with previous results from brainstorming.

32. The method of claim 30, wherein designing further comprises preparing tasks for usability tests.

33. The method of claim 32, wherein the tasks are prepared by trainers substantially simultaneously with the learners filling out the templates.

34. The method of claim 1, further comprising presenting, subsequent to designing and prior to providing prototypes, a lecturette to the learners as an introduction into prototyping.

35. The method of claim 1, wherein providing prototypes is followed by briefing the learners on testing and reviewing the prototype.

36. The method of claim 1, wherein providing prototypes is followed by conducting a prototype usability test.

37. The method of claim 36, wherein the prototype usability test is conducted based on task descriptions.

38. The method of claim 1, wherein providing prototypes is followed by conducting a terminology review by the third group.

39. The method of claim 38, wherein conducting the terminology review comprises reviewing terminology of user interface elements.

40. The method of claim 39, wherein conducting the terminology review comprises reviewing terminology of application content.

41. The method of claim 1, wherein analyzing to provide assistance to the first and second groups comprises permitting the third group to selectively communicate with the first group and the second group only temporarily.

42. The method of claim 1, wherein brainstorming and designing are performed for the first and second groups in visual separation from the third group, and further wherein communication between the first and second groups with the third group is only allowed temporarily.

43. The method of claim 1, wherein the learners are trained to develop user interfaces on technical platforms selected from the group of: Internet platforms, handheld and wireless computer devices, and client/server computer systems.

44. The method of claim 1, wherein dividing, brainstorming, designing, providing and analyzing is supported and supervised by a computer program.

45. The method of claim 1, wherein providing first and second prototypes for the user interfaces comprises providing, by the first group and second group, first and second paper prototypes for the user interfaces according to the first and second usage scenarios, respectively.

46. A method for training a plurality of learners to develop user interfaces for a software application, the method comprising:
dividing the plurality of learners into a plurality of learner groups and a task force group;
brainstorming, by the learner groups, to generate an overall usage context for the user interfaces;
designing, by the learner groups, a plurality of user environments;
providing, by the learner groups, prototypes for the user interfaces according to the plurality of user environments; and
analyzing, by the task force group, existing user interfaces to provide assistance to the learner groups in providing the prototypes.
